(19) United States
(12) Patent Application Publication
(10) Pub. No.: US 2006/0058151 A1
(43) Pub. Date: Mar. 16, 2006

(54) Zero degree operating pressure angle clearing

(75) Inventors: Henry J. Flair, Franklin Park, IL (US); James A. Gruszkowski, Orland Park, IL (US)

Correspondence Address: WELSH & KATZ, LTD. (ILLINOIS TOOL WORKS), 120 S. RIVERSIDE PLAZA, CHICAGO, IL, 60606, US

(73) Assignee: Illinois Tool Works, Inc., Glenview, IL (US)

(21) Appl. No.: 10/939,796

(22) Filed: Sep. 13, 2004

(51) Int. Cl. F16H 57/08

(52) U.S. Cl. 475/331

(57) ABSTRACT

A zero degree operating pressure angle gearing system includes an external gear and a mating gear. The external gear has a plurality of teeth disposed along a periphery of the gear, each of the teeth having a convex profile. The mating gear has a plurality of teeth, each of the teeth having a concave profile. The gears are mated to one another such that an operating pressure angle defined by the gears is substantially zero.

### BACKGROUND OF THE INVENTION

The present invention relates to gearing. More particularly, the present invention relates to zero degree operating pressure angle parallel axis gearing in which one of a pair of gears is of a modified design and is used with a standard (non-modified) gear configuration to achieve the zero degree operating pressure angle.

Gears are perhaps the most commonly used element for transferring mechanical power from a source to an object. For example, automobiles use a wide variety and large number of gears to transfer power from the automobile engine to the drive wheels. A transmission alone can used tens of different gears to transfer power, at differing desired speeds and ratios (in revolutions per minute) from the engine to the wheels (generally through a differential gear).

One arrangement of gears is a parallel axis arrangement in which the rotating axes of the mating gears are parallel. This type of arrangement is used when the driven axis (the axis of the power source) and the drive axis (the axis of the object being driven) are parallel to the same direction. Typically, parallel axis arrangement gears are of the spur or helical type. In spur gears, the gear teeth are oriented straight and parallel to the gear axis. Helical gears have helical shaped teeth that wrap around the gear axis. Gear arrangements can be formed in which both of the (mating) gears have teeth externally disposed on the gear (external gears) or in which one of the gears has teeth formed on an inner periphery of the gear body (internal gear) that mate with an external gear.

The teeth of external (mating) gears are typically formed having convex profiles. Conversely, the teeth of internal gears are typically formed having concave profiles. The point of contact of the teeth moves along the tooth profile from the beginning of contact to the termination of contact (of the meshed teeth). As a result, the point of contact defines an undulating line through the gear contact cycle.

The operating pressure angle of a gear system is the acute angle formed between a line perpendicular to the rotating axes of the gears and a line tangent to the base circles of the gears. In a typical gearing system, the operating pressure angle is between 14° and 25°. The larger the angle, however, the greater the slip or sliding between the gears and the lower the efficiency of the gear system. The operating pressure angle is, however, dependent upon the tooth configuration or profile, and is limited as such.

Accordingly, there is a need for a gearing system having a zero degree pressure angle configuration. Desirably, such a system can be configured using at least one of a standard gear design. More desirably, such a system does not adversely affect the strength of the gears.

### SUMMARY OF THE INVENTION

A zero degree operating pressure angle gearing system includes an external gear having a plurality of teeth disposed along a periphery of the gear and a mating gear. Each of the external gear teeth having a convex profile. Each of the mating gear teeth have a concave profile. The gears are mated to one another such that an operating pressure angle defined by the gears is substantially zero.

In a present system, the mating gear can be an external gear or an internal gear. A planetary gear system includes a ring gear having a concave profile teeth. In such a system, a sun gear is also formed having concave profile teeth and the planet gears are formed having a convex profile. In both gear engagements within the system (i.e., the sun to planet and the plant to ring gear engagements), a zero degree operating pressure angle is achieved.

These and other features and advantages of the present invention will be readily apparent from the following detailed description, in conjunction with the claims.

### BRIEF DESCRIPTION OF THE DRAWINGS

The benefits and advantages of the present invention will become more readily apparent to those of ordinary skill in the relevant art after reviewing the following detailed description and accompanying drawings, wherein:

FIG. 1 is an enlarged, partial schematic illustration of a portion of a gearing system illustrating a portion of a ring gear, a portion of a planet gear and a portion of a sun gear, the gearing system being formed in accordance with the principles of the present invention;

FIG. 2 is a plan view of the gearing system;

FIG. 3 is an enlarged view of a portion of the gearing system of FIG. 2; and

FIG. 4 is an exemplary automobile transmission employing a gearing system such as that illustrated in FIG. 2.

### DETAILED DESCRIPTION OF THE INVENTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated.

It should be understood that the title of this section of this specification, namely, “Detailed Description Of The Invention”, relates to a requirement of the United States Patent Office, and does not imply, nor should be inferred to limit the subject matter disclosed herein.

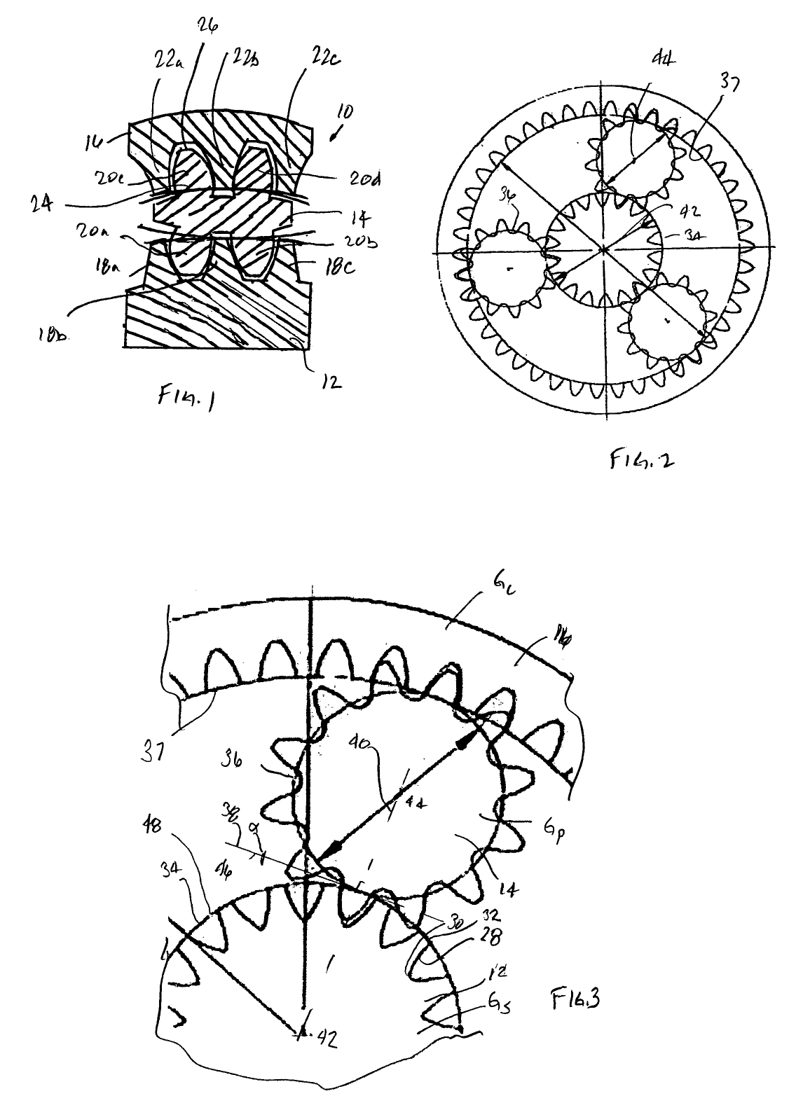

Referring to the figures and in particular to FIG. 1, there is illustrated schematically a portion of a gearing system 10 having a first, centrally disposed external gear 12 that is mated with a plurality of second external gears 14 (see FIG. 2). The second external gears 14 (which are typically identical to one another) are mated with the first gear 12 and with an internal gear 16. The illustrated gearing system 10 is commonly referred to as a planetary gear system. The first external or central gear 12 is referred to as a sun gear, the second external gears 14 are referred to an planet gears or pinions and the internal gear 16 is referred to as a ring gear.

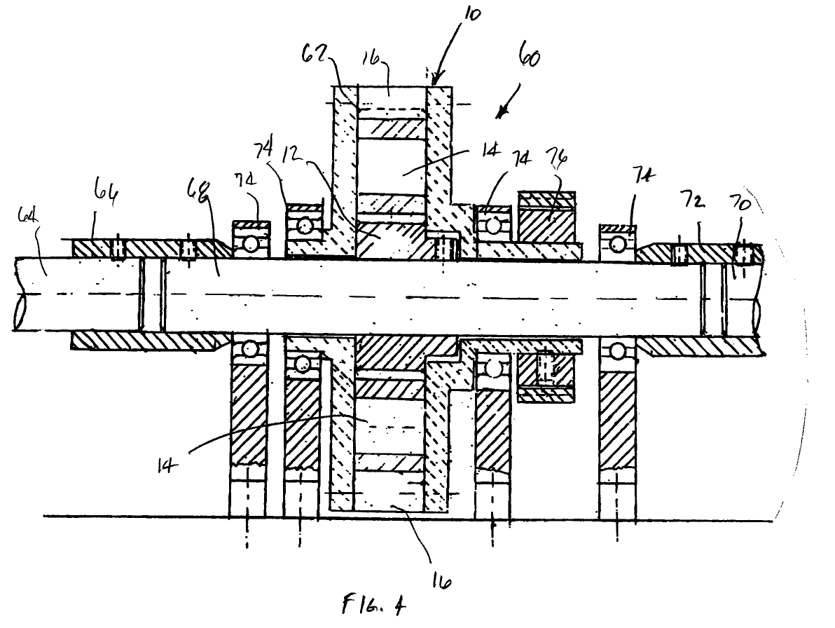

For purposes of the present disclosure, the gears 12, 14, 16 are shown in a simplified, schematic manner in FIGS. 1 and 3 to facilitate description of the various parts of the gears. In FIG. 1, one of the planet gears 14 (planet pinions) is shown with two gear teeth 18a,b mated with three teeth 20a,b,c of the sun gear 12. Two other teeth of the planet gear 18c,d are mated with three teeth 22a,b,c of the ring gear 16.

The planet gears 14 are conventionally formed gears. That is, the teeth 18 of those gears have a convex shape, curving or arcing outwardly between the root 24 and the top land 26 of the tooth 18. The sun gear teeth 20, however, are formed having a concave profile, curving or arcing inwardly (as indicated at 28) between the root 30 and the top land 32. As a result, the operating pressure angle α of the (mating of the) planet 14 and sun 12 gears is zero or near to zero.

FIG. 3 illustrates the relationship between the base circles 34, 36 of the sun 12 and planet 14 gears, respectively and the pressure angle α. As can be seen, the operating pressure angle α is that (acute) angle that is formed between a line (indicated at 38) perpendicular to a line (indicated at 40) between the rotating axes 42, 44 of the gears 12, 14 and a line indicated at 46 tangent to the base circles 34, 36 of the gears 12, 14. Thus, as the distance between the base circles 34, 36 decreases (that is, as the base circles approach one another), the operating pressure angle α decreases. In a typical gearing system, the operating pressure angle is between 14° and 25°. A similar relationship between the base circles 36, 37 of the planet 14 and ring 16 gears, is established as well to create a zero degree pressure angle configuration between the planet and ring gears 14, 16.

As set forth above, the sun gear 12 is formed having a concave profile as at 28. This profile provides for the accommodation of the convex form (from the planet gear 14) in the concave form of the sun gear 12. The accommodation is made by undercutting the tooth 20 (to form the concavity) and by cutting deeper into the body 13 of the sun gear 12. Viewed another way, the outside diameter 48 of the sun gear 12 is made to be close to the base circle diameter of its standard equivalent so that the active tooth profile is below the base circle diameter.

The combination of a deeper cut into the body 13 of the gear 12 in conjunction with mating of the concave and convex gear profiles permits the driving (sun) gear 12 to more efficiently “push” or force the driven (planet) gears 14 by reducing the operating pressure angle α which reduces the slip or sliding that would otherwise occur between the gears 12, 14. Again, this same relationship is established between the planet 14 and ring 16 gears.

As described above, the line of action between two external zero degree operating pressure angle gears is made up of a line (essentially the tangent 46) drawn thru the pitch diameters of two mating gears (on the X-axis), and a right angle line 38 drawn thru the centers of the two rotating gears (on the Y-axis). Defining Gp as the planet gear and Gs as the sun gear. The gears X axis contact starts at the base diameter of the Gp zero degree of roll, and ends when the Gp outer diameter degree of roll is reached. The X axis zero is half way between the Gp degree of roll. The Y axis zero lies on the (Gp and GS) pitch diameter points. There is a vertical component on the Y axis due to the concave shape radius of curvature of the sun gear Gs, and the convex shape radius of curvature of the planet gear Gp. When the two shapes mesh they move in directions as follows. The Gp contact moves from Gp base diameter to Gp outer diameter. The Gs contact moves from the Gs outer diameter to the Gs form diameter. These motions create a continuous (Gp and Gs) pitch diameter rolling action. The accuracy of the (Gp and Gs) pitch circles, depends on the accuracy of the (Gp and Gs) base circle form. The accuracy of the (Gp and Gs) forms are measured on standard profile measuring machines.

The following represents numerical values for mating gears (Gp and Gs). The gears can be helical or spur gears. Angular units are in degrees and distance units are in inches or metric values. For spur gears, the following relationships hold:
where NDP (normal diametral pitch)=DP (diametral pitch),
NTTp (normal tooth thickness of the planet gear)=TTp (tooth thickness of the planet gear),
NTTs (normal tooth thickness of the sun gear)=TTs (tooth thickness of the sun gear),
tpa (transverse pressure angle)=pa (pressure angle), and
Np,Ns=Number of teeth (of the planet and sun gears, spur and helical):

Mates General Equation:
INV(topa)=INV(tpa)+((NTTp+NTTs)*NDP−π)/(1+Ns/Np);

Convex shape tooth thickness equation:
NTTp=π/2*NDP;

Concave teeth equation:
NTTs=(π−INV(tpa)*(1+Ns/Np))/NDP−NTTp;

Pitch Diameter of Sun Gear:
PDs=BDp*(1+Ns/Np)−PDp;

Base Diameter of Sun Gear:
BDs=PDs*COS(tpa);

Operating Center Distance for mating pair:
OCD=BDp(1+Ns/Np)/2;

Outside Diameter of Sun Gear:
ODs=BDp(Ns/Np).
topa=zero degrees for helical gears, opa=zero degrees for spur gears, and where INV is the involute function.

As to internal (ring) gearing, a planet gear with a convex shape is required to mesh with an internal gear to operate at a zero degree operating pressure angle. Let Gp be a planet gear, and Gi be the mating internal gear. The X axis line of action between the two gears start with a common involute zero point of the two base circles. The distance of their base radius is their Y axis value. When the two gears turn around their center of rotation they generate two involute forms.

The planet gear has convex shaped teeth. The internal involute has concave shaped teeth. The planet gear can be used as a guide to design a shaper cutter to generate a zero degree operating angle internal gear.

The following represents numerical values for mating gears (Gp and Gi). The gears can be helical or spur gears. Angular units are in degrees and distance units are in inches or metric values. For spur gears, the following relationships hold:
NDP=DP, NTTp=TTp, NTTi=TTi, tpa=pa, Np, Ni=Number of teeth (of the planet and internal gears, spur and helical)

Mates General Equation:
INV(topa)=INV(tpa)−((NTTp+NTTi)*NDP−π)/(1+Ni/Np);

Convex shape Planet tooth thickness equation:
NTTp=π/2*NDP;

Concave shape Internal tooth equation:
NTTi=(π+INV(tpa)*(1+Ni/Np))/NDP−NTTp;

Pitch Diameter of Internal Gear:
PDi=(BDi²+(BDp*TAN(ACOS(BDp/PDp)))²)^{0.5};

Base Diameter of Internal Gear:
BDi=BDp*Ni/Np;

Operating Center Distance for mating pair:
OCD=(BDi−BDp)/2.
topa=zero degrees for helical gears, opa=zero degrees for spur gears, and where the subscript i represents the values for the internal gear.

A cross-sectional schematic illustration of an exemplary transmission 60 gearing system 10 for a hybrid car is illustrated in FIG. 4. In this arrangement the gear system 10 is illustrated having the ring gear 16, the sun gear 12 and two planet gears 14. The sun gear 12 and the ring gear 16 are modified to form the zero degree operating pressure angle system, while the planet gears 14 are conventional gears. The gearing system 10 is contained within a housing 62, portions of which rotate.

A drive shaft 64 of an internal combustion engine is operably connected to the gearing system 10 by a coupling with 66 a sun gear drive shaft 68. An electric motor shaft 70 is likewise operably connected to the gearing system 10 by a coupling 72. A plurality of bearings 74 support the housing 62 and the drive shafts 64, 68 to permit low friction movement. A belt and pulley 76 can be used to transfer power to the car axle.

Those skilled in the art will appreciate that the present zero degree pressure angle configuration can be used for conventional involute designs as well as other spur and helical gear configurations.

All patents referred to herein, are hereby incorporated herein by reference, whether or not specifically done so within the text of this disclosure.

In the disclosures, the words “a” or “an” are to be taken to include both the singular and the plural. Conversely, any reference to plural items shall, where appropriate, include the singular.

From the foregoing it will be observed that numerous modification and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

What is claimed is:

1. A zero degree operating pressure angle gearing system comprising:
an external gear having a plurality of teeth disposed along a periphery of the gear, each of the teeth having a convex profile; and
a mating gear, the mating gear having a plurality of teeth, each of the teeth having a concave profile,
wherein the gears are mated to one another such that an operating pressure angle defined by the gears is substantially zero.

2. The zero degree operating pressure angle gearing system in accordance with claim 1 wherein the mating gear is an external gear.

3. The zero degree operating pressure angle gearing system in accordance with claim 1 wherein the mating gear is an internal gear.

4. The zero degree operating pressure angle gearing system in accordance with claim 1 including a ring gear having a plurality of teeth, each of the teeth having a concave profile, wherein the mating gear is a sun gear and wherein the gearing system includes a plurality of mating gears, the mating gears being planet gears disposed within the ring gear and outwardly of the sun gear.

5. A zero degree operating pressure angle gearing system comprising:
a first gear having a plurality of teeth, each of the teeth having a convex profile, the first gear defining a first gear base circle; and
a second gear for mating with the first gear, the second gear having a plurality of teeth, each of the teeth having a concave profile, the second gear defining a second gear base circle,
wherein the gears are mated to one another such that an acute angle formed by a line tangent to the base circles of the first and second gear base circles, a line normal to a line between rotational axes of the gears is substantially zero.

6. The zero degree operating pressure angle gearing system in accordance with claim 5 wherein the first gear is an external gear and wherein each of the teeth has a convex tooth profile.

7. The zero degree operating pressure angle gearing system in accordance with claim 6 wherein the second gear is an external gear and wherein each of the teeth has a concave tooth profile.

8. The zero degree operating pressure angle gearing system in accordance with claim 6 wherein the second gear is an internal gear and wherein each of the teeth has a concave tooth profile.

9. The zero degree operating pressure angle gearing system in accordance with claim 5 including a ring gear having a plurality of teeth, each of the teeth having a concave profile, wherein the second gear is a sun gear and wherein the gearing system includes a plurality of planet gears, the disposed within the ring gear and outwardly of the sun gear.
